(19) United States
(12) Patent Application Publication
(10) Pub. No.: US 2018/0126412 A1
(43) Pub. Date: May 10, 2018

(54) THREE-DIMENSIONAL LABEL, PRINTING APPARATUS AND METHOD FOR PRINTING A THREE-DIMENSIONAL LABEL

(71) Applicant: INDUSTRIAL TECHNOLOGY RESEARCH INSTITUTE, Hsinchu (TW)

(72) Inventors: Chih-Hung HUANG, Hsinchu (TW); Li-Wen LAI, Hsinchu (TW); Yang-Cheng LIN, Hsinchu (TW); Cheng-Chi HUANG, Hsinchu (TW)

(73) Assignee: INDUSTRIAL TECHNOLOGY RESEARCH INSTITUTE, Hsinchu (TW)

(21) Appl. No.: 15/409,287

(22) Filed: Jan. 18, 2017

(30) Foreign Application Priority Data
Nov. 10, 2016 (TW) 105136597

(51) Int. Cl. B05D 1/26; B05C 5/02

(52) U.S. Cl. CPC B05D 1/265; B05C 5/02

(57) ABSTRACT

A method for printing a 3D label is provided, which includes: providing a base material on a carrying unit of a printing device; modulating a gap between the base material and the carrying unit to be non-zero; continuously melting and printing at least one material on and in the base material to form a first portion of the 3D label; modulating the gap to be zero as the first portion of the 3D label reaches a predetermined thickness; and continuously melting and printing the material on the first portion of the 3D label to form a second portion of the 3D label. The present disclosure further provides a 3D label and a printing apparatus.

### CROSS-REFERENCE TO RELATED APPLICATION

The present disclosure is based on, and claims priority from Taiwan Application Number 105136597, filed on Nov. 10, 2016, the disclosure of which is hereby incorporated by reference herein in its entirety.

### BACKGROUND

### 1. Technical Field

The present disclosure relates to three-dimensional print techniques, and, more particularly, to a 3D label, a printing apparatus and a printing method thereof.

### 2. Description of Related Art

Pattern labels are widely applied in clothes and sports goods. For example, pattern labels are disposed on porous flexible materials of shirts, pants, sports shoes for decoration or personal identification. Printing of pattern labels are gradually developed from flat screen printing, jet printing to thermal transfer printing. Also, pattern labels are developed from planar patterns to customized 3D patterns. For example, in the thermal transfer printing method, an adhesive layer under a pattern label is hot pressed so as to be transfer printed to a flexible material. However, the adhesive material easily bleeds into a periphery of the hot pressed pattern label. Further, the material generates an unpleasant smell when being heated, thus reducing the product quality and causing inconvenience in use.

Further, fused deposition modeling (FUM) has been developed, which is a 3D printing technology. However, due to the lack of an adhesive layer, the FUM technology has disadvantages of poor bonding strength between the pattern label and the flexible material and over-hardness and easy delamination of the pattern label. Further, when an extrusion head used in the FUM technology moves, it may pull or press against the flexible material, or even damage the printed pattern label due to its high temperature and hence adversely affect the quality of the pattern label.

Therefore, how to overcome the above-described drawbacks has become critical.

### SUMMARY

The present disclosure provides a printing apparatus, which comprises: a printing device for printing a three-dimensional (3D) label, comprising: a carrying unit for carrying a base material; at least one gap control unit disposed on a surface of the carrying unit that carries the base material and for controlling a gap between the base material and the carrying unit; and at least one extrusion head unit disposed over the carrying unit and for melting at least one material and printing the material in and on the base material; and a computing device for controlling the printing device to print the 3D label at a first stage and a second stage following the first stage, the computing device further comprising: a gap adjusting module for controlling the gap control unit to modulate the gap to be non-zero at the first stage and to be zero at the second stage.

The present disclosure further provides a method for printing a 3D label, which comprises: providing a base material on a carrying unit of a printing device; modulating a gap between the base material and the carrying unit to be non-zero; melting and printing, by at least one extrusion head unit of the printing device, at least one material on and in the base material so as to form a first portion of the 3D label; modulating the gap to zero as the first portion of the 3D label reaches a predetermined thickness; and melting and printing, by the extrusion head unit of the printing device, the material on the first portion of the 3D label so as to form a second portion of the 3D label.

The present disclosure further provides a 3D label, which comprises: a base material; a first portion of a material melted and printed in and on the base material; and a second portion of the material melted and printed on the first portion of the material.

### BRIEF DESCRIPTION OF DRAWINGS

FIG. 1 is a schematic diagram of a printing apparatus according to the present disclosure;

FIG. 2 is a partially enlarged view of the printing apparatus according to the present disclosure;

FIG. 3 is a flow chart showing a method for printing a 3D label according to a first embodiment of the present disclosure;

FIG. 4 is a flow chart showing a method for printing a 3D label according to a second embodiment of the present disclosure;

FIG. 5 is a flow chart showing a method for printing a 3D label according to a third embodiment of the present disclosure; and

FIG. 6 is a schematic cross-sectional view of a 3D label printed in and on a base material according to the present disclosure.

### DETAILED DESCRIPTION

The following illustrative embodiments are provided to illustrate the present disclosure, these and other advantages and effects can be apparent to those in the art after reading this specification. It should be noted that all the drawings are not intended to limit the present disclosure. Various modifications and variations can be made without departing from the spirit of the present disclosure.

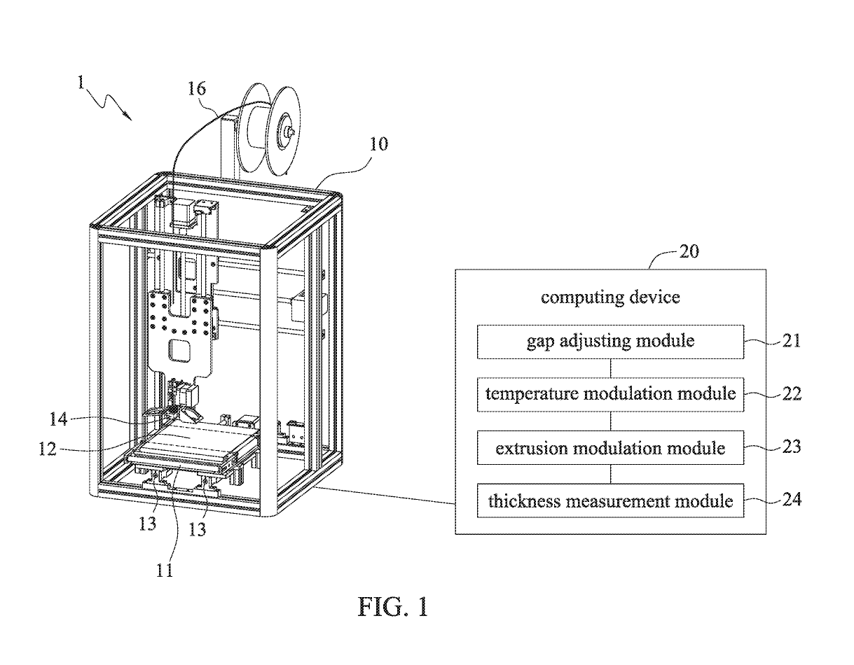

FIG. 1 is a schematic diagram of a printing apparatus 1 according to the present disclosure. The printing apparatus 1 has a printing device 10 and a computing device 20. The printing device 10 is a 1-DM printing device, and the computing device 20 is an electronic device having a processor. For example, the computing device 20 is a computer, a mobile phone, a server or a cloud server.

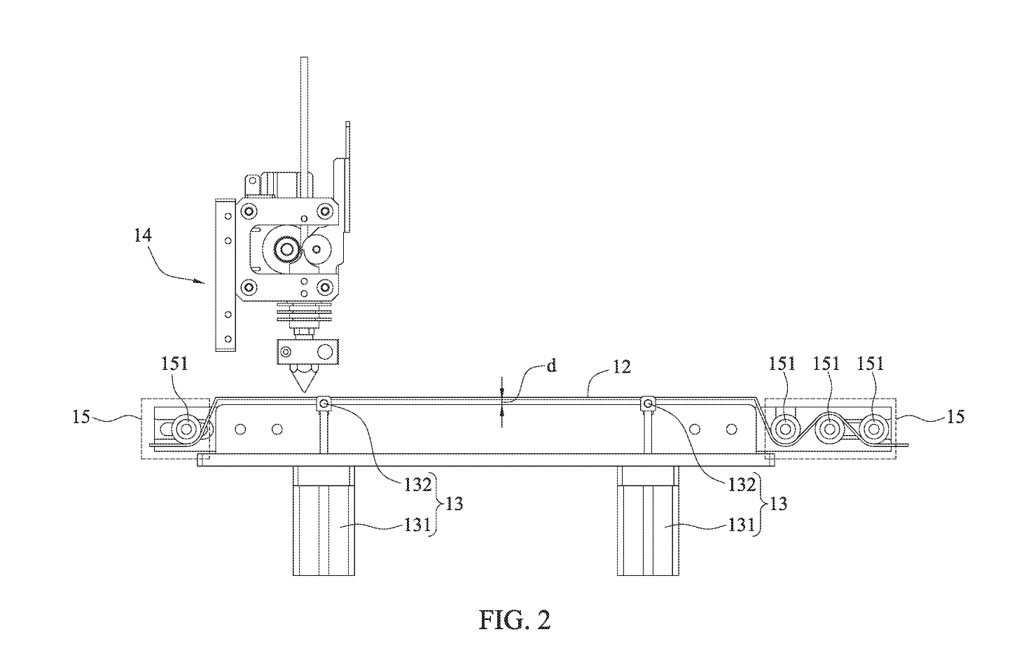

The printing device 10 is used to print a 3D label. The printing device 10 has a carrying unit 11, at least one gap control unit 13 and at least one extrusion head unit 14. Referring to FIGS. 1 and 2, the carrying unit 11 is used to carry a base material 12. In an embodiment, the base material 12 is a porous flexible material, such as knitted fabric or woven fabric made of nylon and spandex or made of polyester.

The gap control unit 13 has a driving element 131 and a rod-shaped element 132. The rod-shaped element 132 is horizontally disposed on the carrying unit 11. The driving element 131 is a pneumatic cylinder, a linear motor or a cam mechanism that controls the rod-shaped element 132 to move in a direction toward or away from a surface of the carrying unit 11. The gap control unit 13 is disposed on the surface of the carrying unit 11 that carries the base material 12. That is, the surface of the carrying unit 11 and the rod-shaped element 132 are positioned under the base material 12. Therefore, the rod-shaped element 132 can be moved to come into contact with the base material 12, thereby controlling a gap d between the base material 12 and the carrying unit 11.

In an embodiment, the printing device 10 further has at least two tension control units 15 disposed on an upstream side (i.e., the tension control unit 15 at the left side of FIG. 2) and a downstream side (i.e., the tension control unit 15 at the right side of FIG. 2) of the carrying unit 11 that carries the base material 12, respectively, and for conveying the base material 12 and controlling the tension of the base material 12 on the carrying unit 11. In an embodiment, each of the tension control units 15 has one or more rollers 151. The base material 12 is attached to surfaces of the rollers 151 in an alternate manner. As such, the base material 12 is brought to move when the rollers 151 rotate, thereby controlling the tension of the base material 12.

The extrusion head unit 14 is disposed over the carrying unit 11 to melt at least one material 16 and print the material 16 in and on the base material 12. In an embodiment, a plurality of extrusion head units 14 are provided to print various materials on the base material 12.

The computing unit 20 is electrically connected to the printing device 10 for controlling the printing device 10 to print the 3D label. The computing device 20 has a gap adjusting module 21, a temperature modulation module 22, an extrusion modulation module 23 and a thickness measurement module 24. The modules according to the present disclosure are software programs to be executed by the processor of the computing device 20. Through control of the software programs, the computing device 20 can divide the 3D label printing process into a first stage and a second stage following the first stage, which will be described later.

The gap adjusting module 21 is used to control operation of the gap control unit 13 so as to modulate the gap d. In an embodiment, the gap adjusting module 21 controls operation of the driving element 131 so as to modulate up and down movement of the rod-shaped element 132 relative to the surface of the carrying unit 11 and thus control the gap d between the base material 12 and the carrying unit 11. At the first stage, the gap d is modulated by the gap adjusting module 21 to be non-zero and have a non-zero specific value, and at the second stage, the gap d is modulated by the gap adjusting module 21 to be zero. In an embodiment, the specific value is within a range of zero to five times of an extruded filament diameter of the extrusion head unit 14. If the gap d is zero, the base material 12 is in contact with the carrying unit 11.

The temperature modulation module 22 is used to control the temperature for the extrusion head unit 14 to melt the material 16. In an embodiment, at the first stage, the temperature of the extrusion head unit 14 is modulated by the temperature modulation module 22 so as to be within a range between a melting temperature and a pyrolysis temperature of the material 16. In an embodiment, the temperature of the extrusion head unit 14 is about 5 to 10° C. lower than the pyrolysis temperature. At this point, the material 16 presents a nearly liquid state and has an increased mobility. At the second stage, the temperature of the extrusion head unit 14 is modulated by the temperature modulation module 22 to be the melting temperature of the material 16. At this point, the material 16 has a lower mobility compared with the first stage. In an embodiment, at the second stage, the temperature of the extrusion head unit 14 is modulated by the temperature modulation module 22 so as to fall a range of the melting temperature of the material 16 plus/minus 10° C.

In an embodiment, the material 16 is a thermoplastic polyurethane (TPU) material, and has a melting temperature of 180 to 190° C. and a pyrolysis temperature of 210 to 220° C. At the first stage, the temperature of the extrusion head unit 14 is modulated by the temperature modulation module 22 to be 205° C. for melting the material 16. Further, at the second stage, the temperature of the extrusion head unit 14 is modulated by the temperature modulation module 22 to be 190° C. for melting the material 16.

In another embodiment, the material 16 is a thermoplastic elastomer (TPE) material, and has a melting temperature of 150 to 170° C. and a pyrolysis temperature of 210 to 230° C. At the first stage, the temperature of the extrusion head unit 14 is modulated by the temperature modulation module 22 to be 200° C. for melting the material 16. Further, at the second stage, the temperature of the extrusion head unit 14 is modulated by the temperature modulation module 22 to be 185° C. for melting the material 16.

In a further embodiment, the material 16 is an ethylene vinyl acetate (EVA) material, and has a melting temperature of 170 to 190° C. and a pyrolysis temperature of 200 to 210° C. At the first stage, the temperature of the extrusion head unit 14 is modulated by the temperature modulation module 22 to be 200° C. for melting the material 16. Further, at the second stage, the temperature of the extrusion head unit 14 is modulated by the temperature modulation module 22 to be 180° C. for melting the material 16.

Those melting and pyrolysis temperatures of embodiments described herein may be different due to different material suppliers.

The extrusion modulation module 23 is used to control the extrusion head unit 14 to extrude the material during printing. The extrusion modulation module 23 controls the extrusion head unit 14 to extrude the material at the first stage less than or equal to the material at the second stage. For example, if the material extruded at the second stage is 100%, the material extruded at the first stage is 80 to 100%.

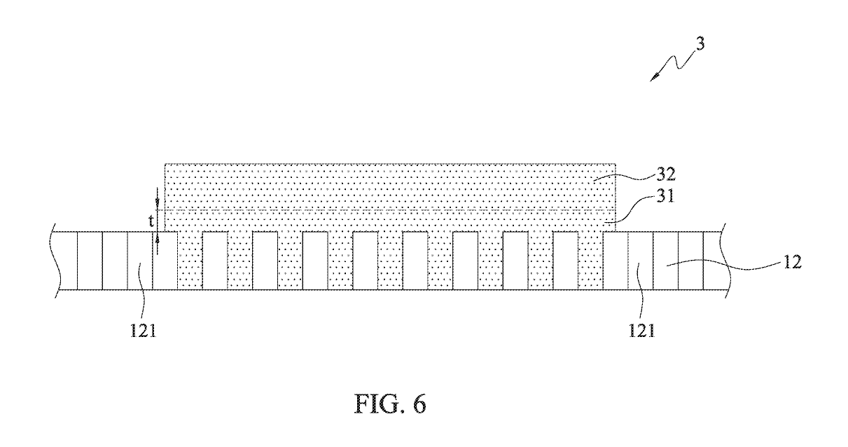

The thickness measurement module 24 is used to measure the thickness of the 3D label printed by the printing device 10 at the first stage, and determines whether the thickness reaches a predetermined thickness t. The thickness is the thickness of the 3D label protruding above the base material 12 (as shown in FIG. 6). If the thickness reaches predetermined thickness t, the printing device 10 is controlled into the second stage. Referring to FIG. 6, the base material 12 is a flexible material having a plurality of pores 121. At the first stage, the gap d is modulated by the gap adjusting module 21 to have a non-zero specific value, and is, for example, within a range of one to five times of an extruded filament diameter of the extrusion head unit 14. As such, the extrusion head unit 14 is in contact with the base material 12 and pressed below the base material 12. When the extrusion head unit 14 performs printing at this state, the material 16 can penetrate into the pores 121 of the base material 12. The extrusion head unit 14 continuously prints until the material 16 protrudes a thickness t above the surface of the base material 12. That is, a first portion 31 of the 3D label 3 is achieved at the first stage. Then, the printing device 10 enters the second stage to print a second portion 32 of the 3D label 3.

Referring to FIG. 6, in an embodiment, the thickness t can be zero. That is, the first portion 31 of the 3D label 3 at the first stage can only fill the pores 121 of the base material 12. In another embodiment, the thickness t can slightly protrude above the surface of the base material 12. As such, a thin film is formed on the surface of the base material 12 for printing the second portion 32 of the 3D label 3.

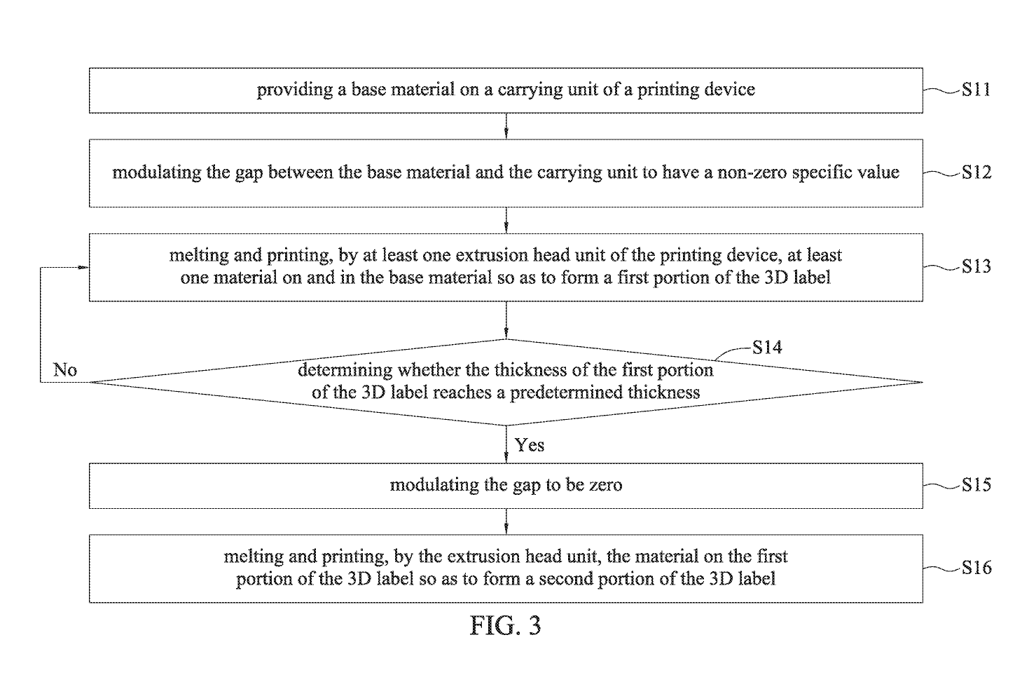

FIG. 3 is a flow chart showing a method for printing a 3D label according to a first embodiment of the present disclosure. The method is performed by using the above-described printing apparatus.

Referring to FIG. 3, first, at step S11, a base material is provided on a carrying unit of a printing device. Then, at step S12, the gap between the base material and the carrying unit is modulated to have a non-zero specific value. In an embodiment, at least one gap control unit is used to modulate the gap. The gap control unit is disposed on the surface of the carrying unit that carries the base material. In another embodiment, the specific value is modulated to be within a range of zero to five times of the extruded filament diameter of the extrusion head unit. Then, the method goes to step S13.

At step S13, at least one extrusion head unit of the printing device continuously melts and prints at least one material on and in the base material so as to form a first portion of the 3D label. Then, the method goes to step S14. At step S14, whether the thickness of the first portion of the 3D label reaches a predetermined thickness is determined. If yes, the method goes to step S15; otherwise, the method goes back to step S13.

At step S15, the gap is modulated to be zero. Then, the method goes to step S16. At step S16, the extrusion head unit continuously melts and prints the material on the first portion of the 3D label so as to form a second portion of the 3D label.

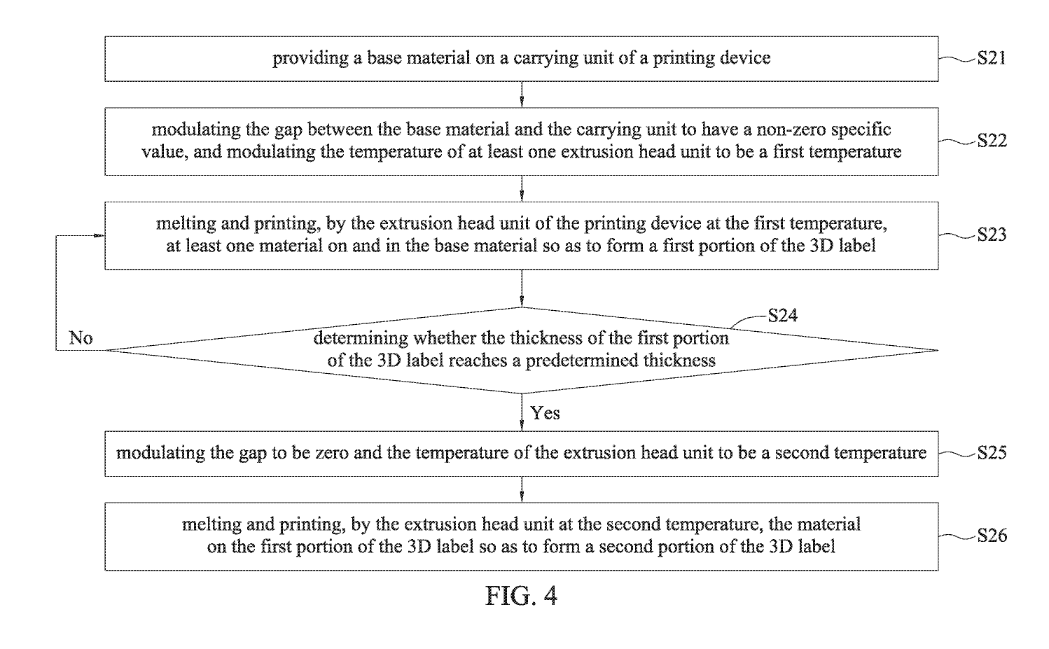

FIG. 4 is a flow chart showing a method for printing a 3D label according to a second embodiment of the present disclosure. The second embodiment differs from the first embodiment in that both the gap between the base material and the carrying unit and the temperature of the extrusion head unit in the second embodiment are modulated.

Referring to FIG. 4, first, at step S21, a base material is provided on a carrying unit of a printing device. Then, the method goes to step S22.

At step S22, the gap between the base material and the carrying unit is modulated to have a non-zero specific value, and at the same time the temperature of at least one extrusion head unit of the printing device is modulated to be a first temperature. The first temperature is within a range between the melting temperature and pyrolysis temperature of the material. Preferably, the first temperature is 5 to 10° C. lower than the pyrolysis temperature. Thereafter, the method goes to step S23.

At step S23, the extrusion head unit at the first temperature continuously melts and prints the material in and on the base material so as to form a first portion of the 3D label. Then, the method goes to step S24. At step S24, whether the thickness of the first portion of the 3D label reaches a predetermined thickness is determined. If yes, the method goes to step S25; otherwise, the method goes back to step S23.

At step S25, the gap is modulated to be zero. At the same time, the temperature of the extrusion head unit is modulated to be a second temperature. The second temperature is within a range of the melting temperature of the material plus/minus 10° C. Then, the method goes to step S26.

At step S26, the extrusion head unit at the second temperature continuously melts and prints the material on the first portion of the 3D label so as to form a second portion of the 3D label.

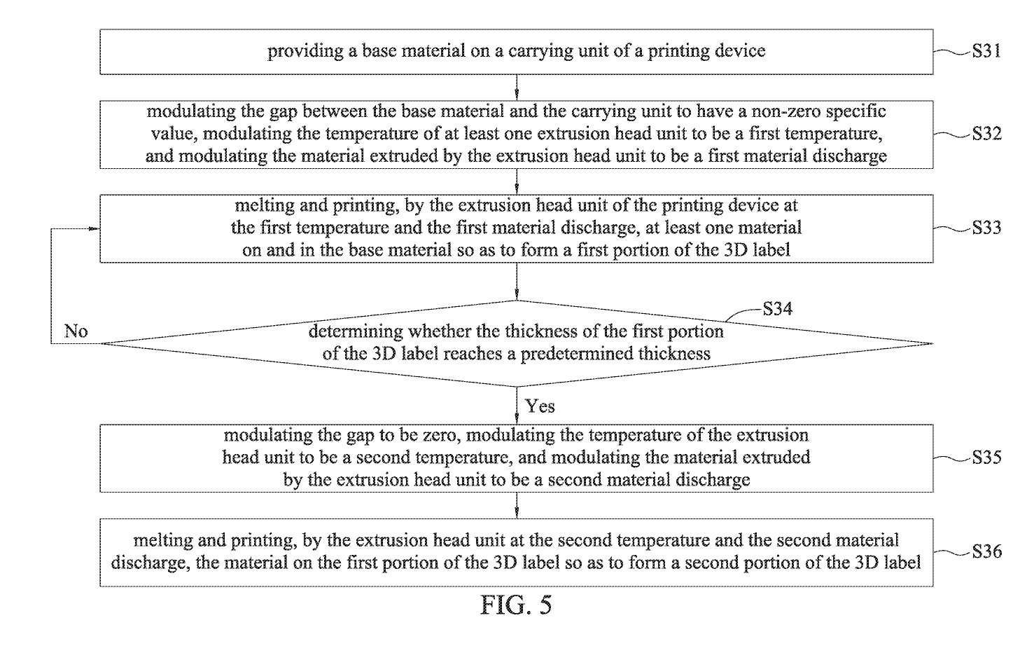

FIG. 5 is a flow chart showing a method for printing a 3D label according to a third embodiment of the present disclosure. The third embodiment differs from the first and second embodiments in that the material extruded by the extrusion head unit in the third embodiment is also modulated.

Referring to FIG. 5, first, at step S31, a base material is provided on a carrying unit of a printing device. Then, the method goes to step S32.

At step S32, the gap between the base material and the carrying unit is modulated to have a non-zero specific value, the temperature of at least one extrusion head unit of the printing device is modulated to be a first temperature, and the material extruded by the extrusion head unit is modulated to be a first material discharge. The first temperature is within a range between the melting temperature and pyrolysis temperature of the material. In an embodiment, the first temperature is 5 to 10° C. lower than the pyrolysis temperature of the material. The first material discharge is 80 to 100% of the normal material discharge. Thereafter, the method goes to step S33.

At step S33, the extrusion head unit at the first temperature and the first material discharge continuously melts and prints the material in and on the base material so as to form a first portion of the 3D label. Then, the method goes to step S34. At step S34, whether the thickness of the first portion of the 3D label reaches a predetermined thickness is determined. If yes, the method goes to step S35; otherwise, the method goes back to step S33.

At step S35, the gap is modulated to be zero. At the same time, the temperature of the extrusion head unit is modulated to be a second temperature and the material extruded by the extrusion head unit is modulated to be a second material discharge. The second temperature is within a range of the melting temperature of the material plus/minus 10° C. The second material discharge is the normal material discharge, i.e., 100%. That is, the material extruded by the extrusion head unit for printing the first portion of the 3D label is less than or equal to the material extruded by the extrusion head unit for printing a second portion of the 3D label. Then, the method goes to step S36.

At step S36, the extrusion head unit at the second temperature and the second material discharge continuously melts and prints the material on the first portion of the 3D label so as to form the second portion of the 3D label.

Referring to FIGS. 1, 2 and 6, the 3D label 3 according to the present disclosure has a base material 12, a first portion 31 of the material and a second portion 32 of the material. The first portion 31 of the material is continuously melted and printed in and on the base material 12 (i.e., in the pores 121 of the base material 12 and on the surface of the base material 12) by the extrusion head unit 14 of the printing device 10. The first portion 31 of the material is formed when the gap d between the base material 12 and the carrying unit 11 has a non-zero specific value. In an embodiment, the specific value is within a range of zero to five times of the extruded filament diameter of the extrusion head unit 14. The temperature of the extrusion head unit 14 is within a range between the melting temperature and pyrolysis temperature of the material for melting the material. In an embodiment, the temperature is 5 to 10° C. lower than the pyrolysis temperature of the material.

The second portion 32 of the material is continuously melted and printed on the first portion 31 of the material by the extrusion head unit 14 of the printing device 10. Therein, the second portion 32 is formed when the thickness of the first portion 31 reaches the predetermined thickness t and the gap between the base material 12 and the carrying unit 11 is zero. The temperature of the extrusion head unit 14 is within a range of the melting temperature of the material plus/minus 10° C. for melting the material.

In an embodiment, the material extruded by the extrusion head unit 14 for forming the first portion 31 is less than or equal to the material extruded by the extrusion head unit 14 for forming the second portion 32.

The following table shows characteristics of some common materials and their applications in the present disclosure.

| | | | | Printing | | | Printing | Material |
|---|---|---|---|---|---|---|---|---|
| | Melting | Pyrolysis | Gap at the | temperature | Material | Gap at the | temperature | discharge at |
| | temperature | temperature | first stage | at the first | discharge at | second stage | at the second | the second |
| Material | (□) | (□) | (mm) | stage (□) | the first stage | (mm) | stage (□) | stage |
| TPU | 180~190 | 210~220 | −15 | 205 | 85% | +0.4 | 190 | 100% |
| TPE | 150~170 | 215~230 | −15 | 200 | 80% | +0.4 | 185 | 100% |
| EVA | 170~190 | 200~210 | −15 | 200 | 85% | +0.4 | 180 | 100% |

According to the present disclosure, a 3D label is printed at two stages. At the first stage, the gap between the base material and the carrying unit is modulated to have a non-zero specific value for printing. As such, the interface of the 3D label bonding with the base material forms a first portion of the 3D label. Then, at the second stage, the gap between the base material and the carrying unit is modulated to be zero for printing. As such, a second portion of the 3D label is formed on the first portion of the 3D label. The first portion of the 3D label can increase the bonding strength between the base material and the 3D label. As such, the 3D label can be integrally formed without the need of any additional adhesive attaching process. Further, through modulation of the gap, the present disclosure prevents the extrusion head unit from damaging the printed portion during the printing process of the first stage and prevents the moving extrusion head unit from causing any wrinkle in the base material. Furthermore, the present disclosure achieves a better printing effect and quality through modulation of the gap and the temperature and material extruded by the extrusion head unit.

The above-described descriptions of the detailed embodiments are only to illustrate the preferred implementation according to the present disclosure, and it is not to limit the scope of the present disclosure. Accordingly, all modifications and variations completed by those with ordinary skill in the art should fall within the scope of present disclosure defined by the appended claims

What is claimed is:

1. A printing apparatus, comprising:
a printing device for printing a three-dimensional (3D) label, comprising:
a carrying unit for carrying a base material;
at least one gap control unit disposed on a surface of the carrying unit that carries the base material and for controlling a gap between the base material and the carrying unit; and
at least one extrusion head unit disposed over the carrying unit and for melting at least one material and printing the material in and on the base material; and
a computing device for controlling the printing device to print the 3D label at a first stage and a second stage following the first stage, the computing device further comprising:
a gap adjusting module for controlling the gap control unit to modulate the gap to be non-zero at the first stage and to be zero at the second stage.

2. The printing apparatus of claim 1, wherein the gap adjusting module controls the gap control unit to modulate the gap to be in a range of zero to five times of an extruded filament diameter of the extrusion head unit.

3. The printing apparatus of claim 1, wherein the computing device further comprises a temperature modulation module for controlling a temperature for the extrusion head unit to melt the material.

4. The printing apparatus of claim 3, wherein the temperature modulation module modulates at the first stage the temperature of the extrusion head unit to be within a range between a melting temperature and a pyrolysis temperature of the material, and modulates at the second stage be within a range of the melting temperature of the material plus/minus 10° C.

5. The printing apparatus of claim 1, wherein the computing device further comprises an extrusion modulation module for controlling the extrusion head unit to extrude the material.

6. The printing apparatus of claim 5, wherein the extrusion modulation module controls the extrusion head unit to extrude the material at the first stage less than or equal to the material at the second stage.

7. The printing apparatus of claim 1, wherein the computing device further comprises a thickness measurement module for measuring the thickness of the 3D label printed at the first stage, and controlling the printing device to enter the second stage as the thickness of the 3D label reaches a predetermined thickness.

8. The printing apparatus of claim 1, wherein the printing device further comprises at least two tension control units disposed at an upstream side and a downstream side of the carrying unit that carries the base material, respectively, and for conveying the base material and controlling a tension of the base material while carried on the carrying unit.

9. The printing apparatus of claim 1, wherein the gap control unit is a pneumatic cylinder, a linear motor, or a cam.

10. A method for printing a 3D label, comprising:
providing a base material on a carrying unit of a printing device;
modulating a gap between the base material and the carrying unit to be non-zero;
melting and printing, by at least one extrusion head unit of the printing device, at least one material on and in the base material so as to form a first portion of the 3D label;
modulating the gap to zero as the first portion of the 3D label reaches a predetermined thickness; and
melting and printing, by the extrusion head unit of the printing device, the material on the first portion of the 3D label so as to form a second portion of the 3D label.

11. The method of claim 10, further comprising disposing on a surface of the carrying unit that carries the base material at least one gap control unit that modulates the gap between the base material and the carrying unit.

12. The method of claim 10, wherein the gap between the base material and the carrying unit is modulated to be within a range of zero to five times of an extruded filament diameter of the extrusion head unit.

13. The method of claim 10, further comprising, before the formation of the first portion of the 3D label, modulating a temperature of the extrusion head unit to be a first temperature.

14. The method of claim 13, wherein the first temperature is within a range between a melting temperature and a pyrolysis temperature of the material.

15. The method of claim 10, further comprising, before the formation of the second portion of the 3D label, modulating the temperature of the extrusion head unit to be a second temperature.

16. The method of claim 15, wherein the second temperature is within a range of the melting temperature of the material plus/minus 10° C.

17. The method of claim 10, further comprising, before the formation of the first or second portion of the 3D label, modulating the extrusion head unit to extrude the material.

18. The method of claim 17, wherein the material extruded by the extrusion head unit for printing the first portion of the 3D label is less than or equal to the material extruded for printing the second portion of the 3D label.

19. A 3D label, comprising:
a base material;
a first portion of a material melted and printed in and on the base material; and
a second portion of the material melted and printed on the first portion of the material.

20. The 3D label of claim 19, wherein at least one extrusion head unit of a printed device continuously melts and prints the first portion of the material in and on the base material that is carried by a carrying unit of the printing device, wherein the first portion of the material is formed when a gap between the base material and the carrying unit is non-zero; and the extrusion head unit of the printed device continuously melts and prints the second portion of the material on the first portion of the material, wherein the second portion of the material is formed when the thickness of the first portion of the material reaches a predetermined thickness and the gap between the base material and the carrying unit is zero.

21. The 3D label of claim 20, wherein the gap is within a range of zero to five times of an extruded filament diameter of the extrusion head unit.

22. The 3D label of claim 20, wherein the extrusion head unit melts the first portion of the material falls at a temperature within a range between a melting temperature and a pyrolysis temperature of the first portion of the material.

23. The 3D label of claim 20, wherein the extrusion head unit melts the second portion of the material at a temperature within a range of the melting temperature of the material plus/minus 10° C.

24. The 3D label of claim 20, wherein the material extruded by the extrusion head unit for printing the first portion of the material is less than or equal to the material extruded for printing the second portion of the material.

25. The 3D label of claim 19, wherein the base material is a porous flexible material.

26. The 3D label of claim 25, wherein the flexible material is knitted fabric or woven fabric made of nylon and spandex or made of polyester.

27. The 3D label of claim 19, wherein the material of the first portion and the second portion is a thermoplastic polyurethane (TPU) material, a thermoplastic elastomer (TPE) material, or an ethylene vinyl acetate (EVA) material.
